(19) United States
(12) Patent Application Publication
(10) Pub. No.: US 2009/0054116 A1
(43) Pub. Date: Feb. 26, 2009

(54) Method and apparatus for scent dispensing

(75) Inventors: Jussi Hakunti, Turku (FI); Annika Hirvonen, Espoo (FI); Ilpo Kauhaniemi, Vantaa (FI); Carl-Magnus Fager, Vantaa (FI); Samu Naukkarinen, Espoo (FI); Pauli Laitinen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/895,627

(22) Filed: Aug. 23, 2007

(51) Int. Cl. H04M 99/00; B05B 17/04

(52) U.S. Cl. 455/899; 239/102.1; 239/4

(57) ABSTRACT

A scent dispenser is integratable into a portable device, such as a mobile handset. The scent dispenser has a vibrating element configured to vibrate in an ultrasound frequency range for dispensing a scent material. Scent dispensing can be in response to an incoming signal received by a mobile handset, but scent dispensing can also be controlled by a user. The scent material is stored in a compartment having a channel with a valve and the vibrating element can be used to open the valve for replenishing the scent material when the vibration is in a low frequency range such as 1-10 Hz. The vibrating element can also be used to produce audio signals. Thus, the scent dispenser can also be integrated with a sound producing unit in a mobile electronic device.

### FIELD OF THE INVENTION

The present invention relates generally to a scent dispenser and, more particularly, to a scent dispenser which can be attached to or integrated into a mobile electronic device, such as a mobile handset.

### BACKGROUND OF THE INVENTION

It would be desirable to have a mobile electronic device, such as a mobile handset, that dispenses a scent when it is used. Some of the existing mobile handsets have, for example, a scent dispenser wherein the fragrant material must be heated in order to generate sufficient amount of scent. Heating a fragrant or perfumed material can create a somewhat long-term scent. The scent, however, may become unnoticeable to the phone user because olfactory adaptation to a scent often occurs shortly after exposure. Furthermore, heating a perfume may eventually cause the material to be rancid.

It would be advantageous to provide a scent generation unit in a mobile handset without the need of heating the fragrant material.

### SUMMARY OF THE INVENTION

The present invention provides a method and apparatus for emitting scent. In particular, the present invention provides a scent dispenser that can be integrated into a mobile electronic device, such as a mobile handset. The scent dispenser has a vibrating element to dispense a perfume or scent when the vibrating element vibrates in a high frequency range such as the ultrasound frequencies. When the vibrating element vibrates in a low frequency, such as between 1 to 10 Hz, it can be used to open a valve, for example. As such, when the scent dispenser is coupled to a source unit through a channel having such a valve, the scent material in the scent dispenser can be replenished by moving part of the scent material in the source unit into the scent dispenser through the channel. Furthermore, the scent dispenser can be integrated into a sound producing unit, such as a speaker or a buzzer. As such, the vibrating element can be used to produce an audio signal when vibrating in a frequency range substantially between 20 Hz to 2 kHz.

Thus, the first aspect of the present invention is a method for scent dispensing, the method comprising:

vibrating a vibrateable element in a first frequency range for dispensing at least a part of a scent material stored in a compartment; and

vibrating the vibrateable element in a second frequency range lower than the first frequency range for moving the scent material into the compartment.

According to one embodiment of the present invention, the scent material is stored adjacent to the vibrateable element.

According to one embodiment of the present invention, apertures are provided on the vibrating element so that the scent material is dispersed through at least some of the apertures.

According to another embodiment of the present invention, the method further comprises:

coupling a second vibrateable element to the vibrateable element, wherein the scent material is stored adjacent to the second vibrateable element, and wherein when the vibrateable element vibrates in the first frequency range, the second vibrateable element vibrates for dispersing the scent material.

According to one embodiment of the present invention, apertures are provided on the second vibrating element so that the scent material is dispersed through at least some of the apertures.

According to one embodiment of the present invention, the method further comprises:

providing a channel between the compartment and a source unit also having the scent material; and

providing a valve at the channel, the valve configured to open in response to vibrations in the second frequency range for moving a part of the scent material in the source unit into the compartment through the channel.

According to one embodiment of the present invention, the vibrateable element is coupled to a processor in a mobile handset configured to receive an incoming signal, wherein the vibrateable element is configured to vibrate in the first frequency range in response to the incoming signal.

The second aspect of the present invention is a device, comprising:

a compartment for storing a scent material; and

a vibrateable element configured to vibrate in a first frequency range for dispensing the scent material, and to vibrate in a second lower frequency range for replenishing the scent material in the compartment.

According to one embodiment of the present invention, the vibrateable element is located in the compartment and the scent material is stored adjacent to the vibrateable element.

According to one embodiment of the present invention, the vibrateable element has a plurality of apertures in at least a part of the vibrateable element, wherein the apertures are sized to move at least some of the scent material therethrough when the vibrateable element vibrates in the first frequency range.

According to another embodiment of the present invention, the device further comprises:

a second vibrateable element coupled to the vibrateable element, the second vibrateable element located in the compartment, wherein the scent material is stored adjacent to the second vibrateable element, and the second vibrateable element is configured to vibrate for dispensing the scent material when the vibrateable element vibrates in the first frequency range.

According to one embodiment of the present invention, the second vibrateable element has a plurality of apertures in at least a part of the second vibrateable element, wherein the apertures are sized to move at least some of the scent material therethrough when the vibrateable element vibrates in the first frequency range.

According to one embodiment of the present invention, the compartment has a channel configured for linking the compartment to a scent source, said device further comprising:

a valve located at the channel of the compartment, wherein the valve is configured to open in response to vibrations in the second frequency range for moving the scent material from a scent source into the compartment through the channel.

According to one embodiment of the present invention, the compartment has a surface spaced from the vibrateable element by a distance sufficiently small such that a capillary effect is produced for retaining the scent material located between the surface and the vibrateable element.

According to one embodiment of the present invention, the vibrateable element is coupled to a mobile electronic device configured to receive an incoming signal, and wherein the vibrateable element is configured to vibrate in the first frequency range in response to an incoming signal received in mobile electronic device.

The third aspect of the present invention is an apparatus, comprising:

a compartment for storing a scent material;

a vibrateable element located in relationship to the compartment; and

a driving unit coupled to the vibrateable element, wherein the driving unit is configured to vibrate the vibrateable element in a first frequency range for dispensing at least a part of the scent material in the compartment, and to vibrate the vibrateable element in a second lower frequency range for replenishing the scent material in compartment.

According to one embodiment of the present invention, the driving unit is also configured to vibrate the vibrateable element in a third frequency range between the first and second frequency ranges for producing an audio signal. The first frequency range is substantially between 50 kHz and 300 kHz; the second frequency range is substantially between 1 Hz and 10 Hz; and the third frequency range is substantially between 20 Hz and 2 kHz, for example.

According to one embodiment of the present invention, the apparatus further comprises a receiver for receiving incoming signals, the receiver coupled to the driving unit, wherein the driver is configured to vibrate the vibrateable element in the first frequency range in response to the incoming signals.

According to one embodiment of the present invention, the compartment comprises a plurality of sub-compartments, each sub-compartment having a valve, and wherein the scent material comprises a plurality of different scents stored in said different sub-compartments, said apparatus further comprising:

a controller coupled to the receiver, wherein the controller is configured to open the valve of a different one of the sub-compartments in response to a selected one of the incoming signals.

According to one embodiment of the present invention, the compartment has a channel configured for linking to a scent source also having the scent material, and a valve located at the channel, wherein the valve is configured to open in response to vibrations in the second frequency for moving at least part of the scent material in the scent source into the compartment through the channel.

The apparatus can be a mobile electronic device, such as mobile handset.

The fourth aspect of the present invention is an apparatus, comprising:

means for storing a scent material;

means for vibrating; and

means, coupled to said vibrating means, for driving said vibrating means to vibrate in the first frequency range for dispensing the scent material, and to vibrate in a second lower frequency for moving the scent material into said storing means.

According to one embodiment of the present invention, the apparatus further comprises:

means for receiving a signal, coupled to the driving means, wherein the driving means is configured to vibrate the vibrating means in the first frequency range in response to the signal.

According to one embodiment of the present invention, the signal comprises an incoming signal received in a mobile terminal, and wherein said receiving means is coupled to a transceiver in the mobile terminal to receive the incoming signal.

The present invention will become apparent upon reading the description taken in conjunction with FIGS. 1 to 14.

### BRIEF DESCRIPTION OF THE DRAWINGS

FIG. 1 shows a mobile handset having a scent dispenser, according to one embodiment of the present invention.

FIG. 2 shows a scent dispensing unit having a perforated vibrating element for dispensing a perfumed material, according to one embodiment of the present invention.

FIG. 3 shows a scent dispensing unit having a perforated vibrating element for dispensing a perfumed material, according to another embodiment of the present invention.

FIG. 4 shows a scent dispensing unit having a perforated membrane for dispensing a perfumed material, according to yet another embodiment of the present invention.

FIG. 5 shows a scent dispensing unit having a vibrating element linking to a perforated element for dispensing a perfumed material, according to one embodiment of the present invention.

FIG. 6 shows a scent dispensing unit having a passive perforated element for allowing a perfumed material to dispense therethrough, according to one embodiment of the present invention.

FIG. 7 shows a scent dispensing unit having an attached vibrating element for dispensing a perfumed material through a passive perforated element, according to one embodiment of the present invention.

FIG. 8 shows a scent dispenser having a valve to intake liquid perfume from a bulk liquid perfume source, according to one embodiment of the present invention.

FIG. 9 shows a scent dispenser having a valve to intake liquid perfume from a bulk liquid perfume source, according to another embodiment of the present invention.

FIG. 10 shows a scent dispenser having a valve to intake liquid perfume from a bulk liquid perfume source, according to yet another embodiment of the present invention.

FIG. 11 shows a scent dispenser having a valve to intake liquid perfume from a bulk liquid perfume source, according to a different embodiment of the present invention.

FIG. 12a to FIG. 12d show a scent dispenser having two scent compartments and two valves for controlling the intake of the scent material, wherein the scent dispenser has a stationary perforated plate.

FIG. 13a to FIG. 13d show a scent dispenser having two scent compartments and two valves for controlling the intake of the scent material, wherein the scent dispenser has a vibrating perforated plate.

FIG. 14 shows a scent dispenser having a plurality of liquid perfume containers for storing different liquid perfumes so that a perfume can be released according to a particular caller.

### DETAILED DESCRIPTION OF THE INVENTION

The scent dispenser, according to various embodiments of the present invention, can be integrated into a mobile electronic device, such as a mobile handset. The scent dispenser has a vibrating element which is configured to vibrate at various frequencies. Thus, according to some embodiments of the present invention, the actuator solution for producing sound is also used for scent dispensing. The actuator can be a vibrating element for producing sound in a speaker or a buzzer in a mobile phone. When the vibrating element is used for producing an audio sound, the vibrating frequency is substantially within the range of 20 Hz to 2 kHz. When the same vibrating element is used for dispensing a perfumed material, the vibrating frequency can be increased to 50 kHz to 300 kHz, for example. Furthermore, in some embodiments of the present invention, a valve is used as a pump to provide the liquid perfume to the scent material chamber, the valve is responsive to the vibrating frequency in the 1-10 Hz range, for example, so that the scent material can be replenished from a larger storage compartment.

The scent dispenser, according to the present invention, can be integrated into a mobile electronic device, as shown in FIG. 1. The scent dispenser can be a stand-alone unit or integrated with a speaker or a buzzer in the mobile electronic device.

According to various embodiments of the present invention, the scent is dispensed as a liquid spray through a plurality of micron-sized holes, for example. FIG. 2 shows one embodiment of the present invention, where a liquid perfume container is attached to a vibrating element. Where the vibrating element is linked to the liquid perfume container, a number of small holes are made on the vibrating element so as to allow the liquid to pass through when the vibrating element is vibrating in the 50 kHz to 300 kHz range. The vibrating element can be a ring-shaped (annular) piezoelectric element having a perforated area substantially in the middle for scent dispensing. The perforated area functions like a micro-pump to pump the liquid through the micron-sized hole only at the ultrasound frequencies, for example. Thus, when the piezoelectric element vibrates in the audio frequency range, no significant amount of scent is dispensed. When the piezoelectric element is vibrating in the 50 kHz to 300 kHz range, sufficient amount of scent is dispensed while no audio sound is produced.

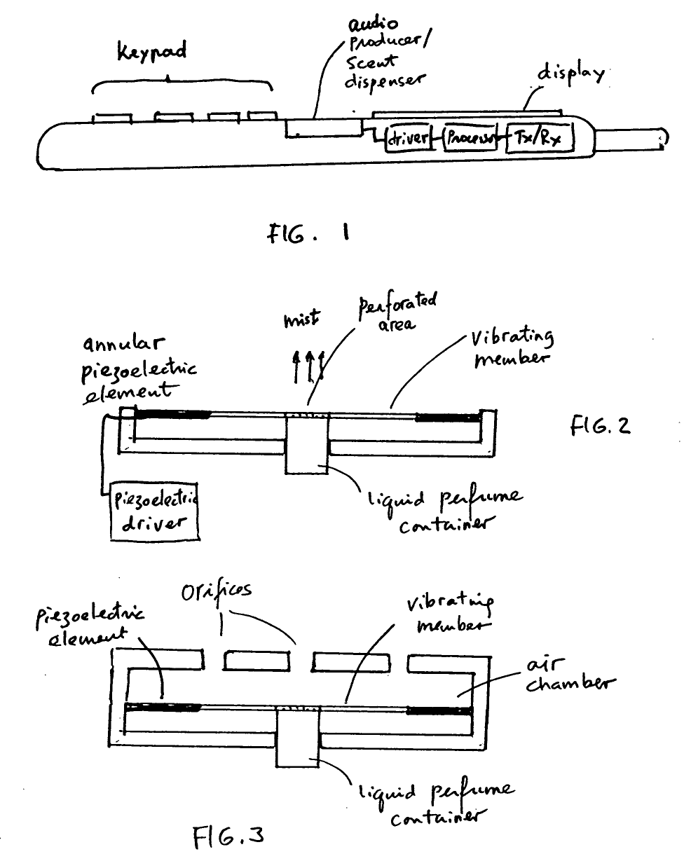

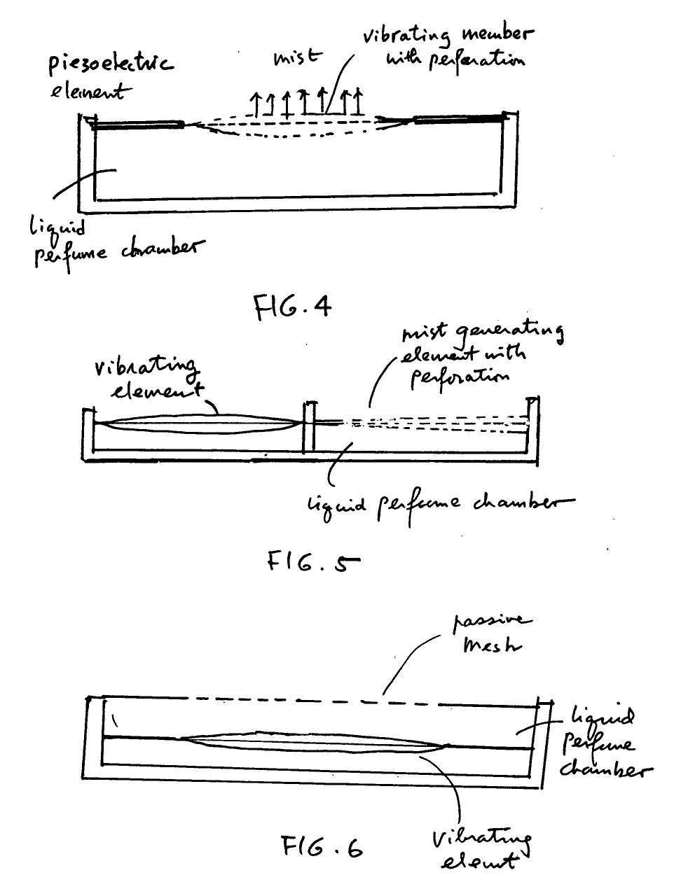

The scent dispenser or the sound producing unit can be a Helmholtz-typed device where a number of orifices are made on a plate covering an air chamber, as shown in FIG. 3. In this embodiment, sound waves are generated through the orifices when the vibrating element is vibrating in the audio frequency range and the liquid mist is delivered through the orifices when the vibrating element is vibrating in the ultrasound frequency range, for example.

In a different embodiment of the present invention, a perforated membrane is used as a cover of a liquid perfume chamber, as shown in FIG. 4. The perforated membrane has a plurality of micron-sized holes within a certain area and is used to deliver a mist of liquid perfume when it vibrates in the ultrasound frequency range, for example. The same membrane can also be used to produce audio sound. The perforated membrane can be a part of an annular piezoelectric element, for example.

In another embodiment of the present invention, the perforated element is only used to dispense the liquid perfume, but not to produce sound. As shown in FIG. 5, the perforated element is coupled to a sound producing membrane disposed in a separate compartment. When the sound producing membrane vibrates, it causes the perforated element to vibrate accordingly. When the sound producing membrane vibrates in the ultrasound frequency range, the perforated element also vibrates in a high frequency range to generate a mist of perfume.

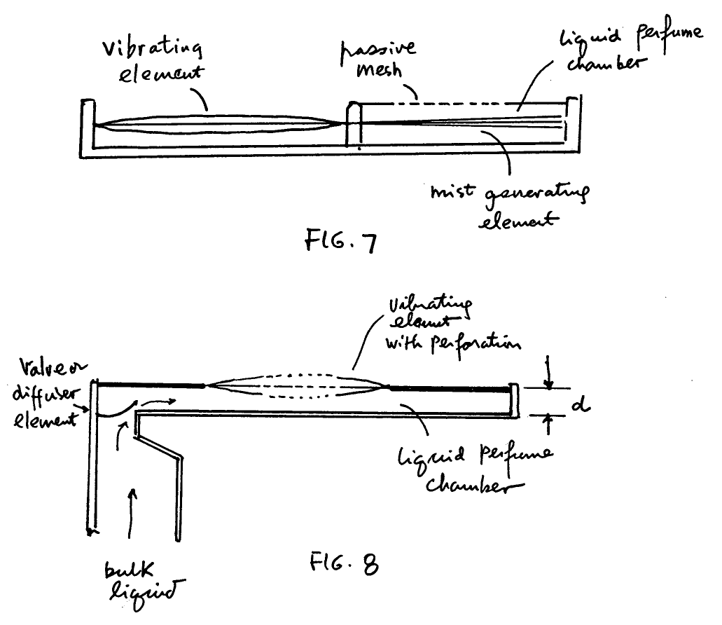

FIGS. 6 and 7 show two different embodiments of the present invention wherein the perforated element remains stationary or passive when the scent is dispensed. As shown in FIG. 6, the perforated element is disposed separately from the vibrating membrane or element. The perforated element can be sufficiently rigid and has a plurality of holes or openings large enough to allow sound waves and the perfume mist to pass through. The vibrating element is programmed to vibrate in the audio frequency range to produce audio sound and to vibrate in a higher frequency to generate a mist through the openings.

In the embodiment as shown in FIG. 7, the mist-generating element is coupled to a vibrating membrane disposed in a separate compartment. When the vibrating membrane vibrates, it causes the mist-generating element to vibrate accordingly. When the vibrating membrane vibrates in the ultrasound frequency range, the mist-generating element also vibrates in a high frequency range to generate a mist of perfume through the passive perforated element.

When a mobile handset is oriented such that the scent dispenser is oriented vertically, for example, the liquid perfume may be pulled away from the perforated membrane or the mist-generating element by gravity. As such, the amount of mist dispensed from the scent dispenser may be significantly reduced. In a variety of embodiments of the present invention, the compartment that is used to store the liquid perfume can be made very thin so that the liquid perfume can be substantially retained by the compartment walls due to the liquid-solid surface tension and the capillary effect (capillarity). For example, the distance between the vibrating membrane or element and compartment base is only a fraction of a millimeter. As such, the liquid perfume is almost in contact with a large part of the vibrating membrane or element, regardless of the orientation of the mobile handset. In order to replenish the liquid perfume in the scent dispenser compartment, bulk liquid is provided to the scent dispenser compartment through a valve or a diffusing element. According to the present invention, the valve or diffusing element can be caused to open by acoustic pressure when the vibrating element vibrates in the 1-20 Hz range, for example. A few examples of orientation-independent scent dispenser units are shown in FIGS. 8 to 13d.

FIG. 8 shows a valve or diffuser element disposed in a scent dispenser unit similar to that illustrated in FIG. 4. In FIG. 8, the distance d between the vibrating membrane and the compartment base is only a fraction of a millimeter in order to produce the capillary effect, whereas the scent dispenser as shown in FIG. 4 can be made thickness to store more liquid perfume therein. The valve can be made of a flexible material such that it responds more efficiently to an acoustic wave in a low frequency range. For example, the valve vibrates more efficiently in the Hz range than in the audio frequency range. Thus, the scent dispenser unit is configured to vibrate in three different frequency ranges. When the scent dispenser unit is used as a speaker or buzzer, the vibrating membrane is caused to vibrate in the audio frequency range. When the scent dispenser unit is used to generate a mist of perfume, the vibrating membrane is caused to vibrate in the ultrasound frequency range. When it is time to replenish the liquid perfume in the scent dispenser compartment, the vibrating membrane is caused to vibrate in a frequency lower than the audio frequency range.

FIG. 9 shows a valve or diffuser element disposed in a scent dispenser unit similar to that illustrated in FIG. 5. In FIG. 9, the distance d between the vibrating membrane and the compartment base is only a fraction of a millimeter in order to produce the capillary effect, whereas the scent dispenser as shown in FIG. 5 can be made to have a sufficient thickness to store more liquid perfume therein.

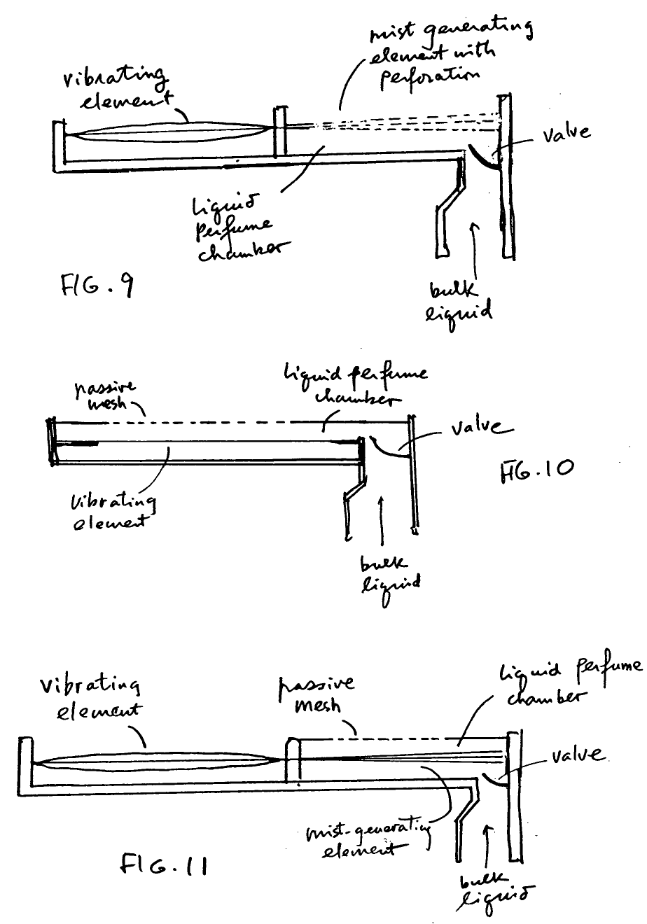

FIG. 10 shows a valve disposed in a scent dispenser unit similar to that illustrated in FIG. 6. In FIG. 10, the distance d between the vibrating membrane and the compartment base is only a fraction of a millimeter in order to produce the capillary effect, whereas the scent dispenser as shown in FIG. 6 can be made at a thickness to store more liquid perfume therein.

FIG. 11 shows a valve disposed in a scent dispenser unit similar to that illustrated in FIG. 7. In FIG. 11, the distance d between the vibrating membrane and the compartment base is only a fraction of a millimeter in order to produce the capillary effect, whereas the scent dispenser as shown in FIG. 7 can be made at a thickness to store more liquid perfume therein.

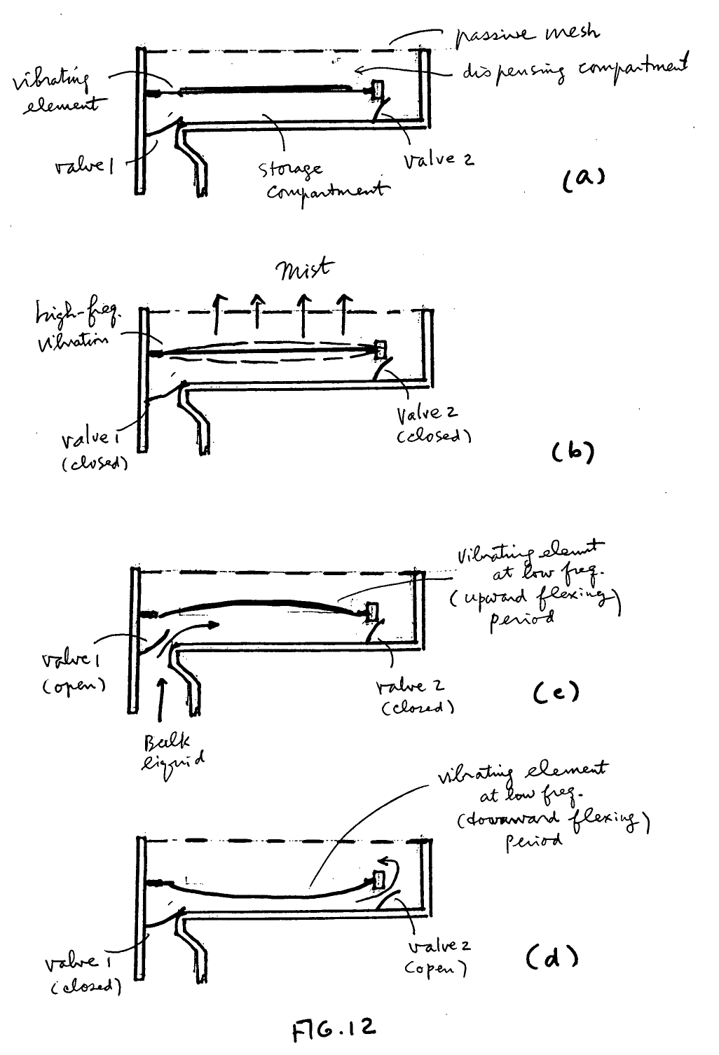

FIG. 12a to FIG. 12d show a scent dispenser having two scent compartments and two valves for controlling the intake of the scent material, wherein the scent dispenser has a stationary perforated plate. FIG. 12a shows the various components of the scent dispenser. As shown, the scent dispenser has two compartments: a scent dispensing compartment defined by a stationary or passive perforated plate and a vibrating element, and a scent storage compartment on the other side of the vibrating element. The scent dispenser has a first valve for controlling the scent intake into the storage compartment from a scent source (not shown), and a second valve for controlling the scent flow into the dispensing compartment from the storage compartment.

FIG. 12b shows the scent dispenser in the scent dispensing mode. As shown in FIG. 12b, the vibrating element vibrates in a high frequency range to produce a mist of scent through the perforated plate. The first and second valves are configured such that they are not significantly responsive to high frequency vibrations. As such, both of the valves remain closed through the scent dispensing period.

FIGS. 12c and 12d shows the scent dispenser in the pumping mode. In this mode, the vibrating element vibrates at a low frequency range. As shown in FIG. 12c, when the vibrating element is in the upward flexing period, it pulls up the first valve to cause the scent material from a source to flow into the storage compartment. As shown in FIG. 12d, when the vibrating element is in the downward flexing period, it causes the first valve to close but pushes open the second valve in order to replenish the scent material in the scent dispensing compartment.

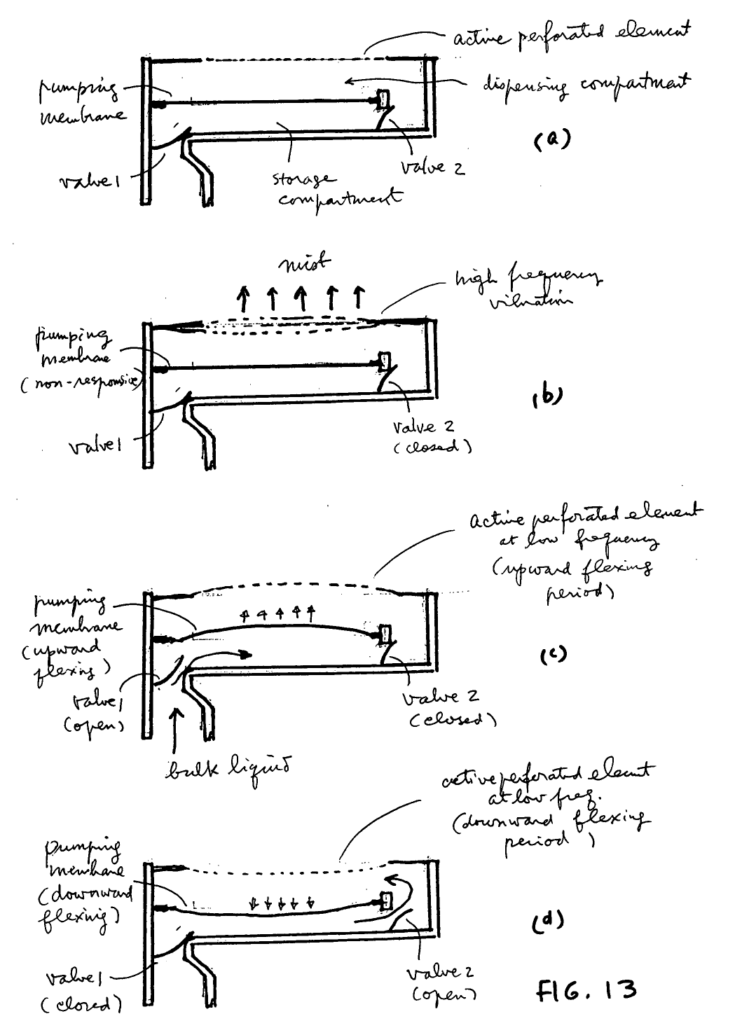

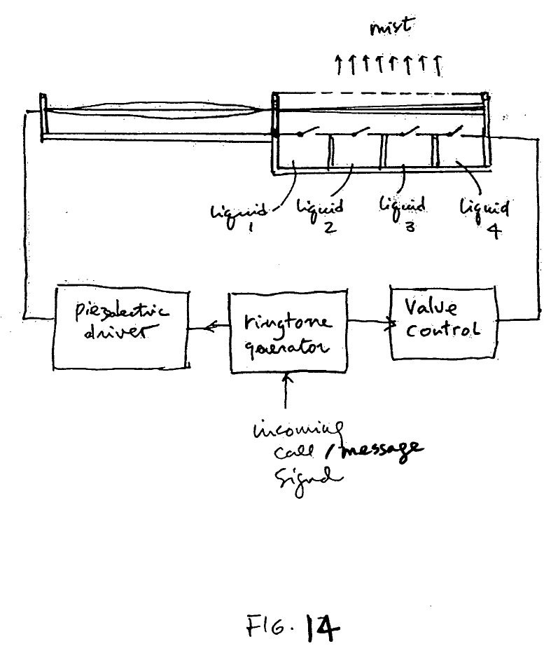

FIG. 13a to FIG. 13d show a scent dispenser having two scent compartments and two valves for controlling the intake of the scent material, wherein the scent dispenser has an active perforated element. FIG. 13a shows the various components of the scent dispenser. As shown, the scent dispenser has two compartments: a scent dispensing compartment defined by an active or vibrateable perforated element and a pumping membrane, and a scent storage compartment on the other side of the pumping membrane. The scent dispenser has a first valve for controlling the scent intake into the storage compartment from a scent source, and a second valve for controlling the scent flow into the dispensing compartment from the storage compartment.

FIG. 13b shows the scent dispenser in the scent dispensing mode. As shown in FIG. 13b, the perforated element vibrates in a high frequency range to produce a mist of scent through the perforated element. The pumping membrane is configured such that it is not significantly responsive to high frequency vibrations. As such, the pumping membrane does not create a pressure on the first and second valves. Thus, the valves remain closed through the scent dispensing period.

FIGS. 13c and 13d shows the scent dispenser in the pumping mode. In this mode, the perforated element vibrates at a low frequency range. As shown in FIG. 13c, when the perforated element is in the upward flexing period, it creates a negative pressure to pull up the pumping membrane. At the same time, the first valve is open to allow the scent material from a source to flow into the storage compartment. As shown in FIG. 13d, when the vibrating element is the downward flexing period, it creates a downward pressure to push down the pumping membrane. As such, the first valve is closed but the second valve is open in order to replenish the scent material in the scent dispensing compartment. It should be noted that the pumping membrane is not necessary for the scent dispense to function. Nevertheless, it would be advantageous to have two scent compartments wherein each of the compartments is made thin enough to create the capillary effect in order to retain the liquid material in place regardless of the orientation of the scent dispenser. The capillary effect is particularly useful when it is used in a mobile electronic device, such as a mobile handset.

In sum, the present invention provides a method of scent dispensing in an electronic device, such as a mobile handset. The scent dispensing unit can be a stand-alone unit, or it can be integrated with a sound producing unit that has a vibrating element which is configured to vibrate in different frequency ranges. When the sound producing unit is used to produce an audio sound or used as a speaker, the vibrating element is caused to vibrate in an audio frequency range. When the sound producing unit is used for scent dispensing, the vibrating element is caused to vibrate in a higher frequency range, such as the ultrasound frequency range. The vibrating element can be disposed adjacent to a perforated element for generating a mist of perfume through the perforated element. Alternatively, the vibrating element can have a plurality of openings to allow a mist of liquid perfume to pass therethrough when the vibrating element vibrates in the higher frequency range. In a different embodiment, the vibrating element is coupled to a mist-generating element disposed in a separate compartment so that the vibrating element causes the mist-generating element to vibrate accordingly. The vibrating element can be configured to vibrate in a frequency range lower than the audio frequency range to actuate a valve or diffusing element in order to replenish the liquid perfume in the scent dispenser unit.

The present invention provides a variety of embodiments of the scent dispenser unit that can be integrated with a speaker or buzzer in a device, such as a mobile terminal. But any one of the embodiments can be a stand-alone scent dispenser. The stand-alone scent dispenser can be designed as an add-on to a mobile electronic device. The electronic device for driving the piezoelectric element can be integrated into the stand-alone dispenser. Alternatively, the driving signal applied to the piezoelectric element is a part of the mobile electronic device. Likewise, the scent dispenser can have its own battery or it can use the electrical power of the mobile electronic device. Also, a control bottom can be provided on the scent dispenser or on the mobile electronic device so as to allow the user to dispense the scent at anytime, without waiting for an incoming signal.

When the user attaches a scent dispensing module to a phone, for example, the user may be asked whether he or she would want to be part of a mailing list, to receive background graphic to the phone, etc. In this way, the phone can be personalized.

The scent dispensers come with a variety of scents so as to allow a user to choose the desirable ones. The scent dispensers can be attached or detached in an easy way so as to allow a user to change the scents to the user's liking. The scent dispenser unit has a mist-generating element for dispensing a scent when a user is using the mobile terminal. For example, a scent is dispensed when the mobile terminal receives an incoming call/message signal. The scent or perfume can be customized by adding a selected scent unit. Accordingly to a different embodiment of the present invention, the scent dispenser unit has a number of separate liquid perfume containers, each of which stores a different perfume, as illustrated in FIG. 14. A plurality of valves can be coupled to a value controller so that a certain liquid perfume container will be opened in response to a certain ring-tone or call number. As such, scents can be used as an information delivery channel to provide a method for personalized call identification from a distance, with no physical contact with the device. Adding a movement/touch sensor to a phone to initiate scent dispensing ensures that the information is delivered to the user immediately after entering the surroundings of the phone.

The present invention provides an actuator solution for producing both audio as a speaker and a scent mist-generating device with independent driving solutions based on intelligent actuator structure and different operating frequency ranges of applications.

In some embodiments, the modified Helmholtz-type resonator used in speaker solutions is used for scent generation, where liquid from an exchangeable or refillable container is delivered on one side of the vibrating plate. The actuator can be a perforated or mesh plate containing hundreds or thousands of micron sized holes through which a liquid perfume is able to penetrate only when the mesh is vibrating. The liquid from the container can be dispensed using e.g. a small pump or a wick (based on capillarity). Usable frequency range is at far ultrasonic range between 100-300 kHz, for example.

The Helmholtz-type resonator can have a ring-shaped piezoelectric element with a a perforated plate in the middle of piezoelectric element. A piezoelectric actuator has an especially large dynamic frequency range to cover both the audio range and the far ultrasonic range required for scent dispensing. Thus, the scent dispenser unit uses a shared piezoelectric element to produce both sound and scent. When vibrated without exposure to the liquid perfume, the device works as a normal speaker or buzzer. With exposure to the liquid perfume, the vibration of the perforated plate works as a micro-pump pumping the liquid through the micron sized holes on the plate and creating a mist of perfume. It is understood that the piezoelectric or vibrating element, as shown in FIGS. 2 to 11, is coupled to a driving unit similar to the one illustrated in FIG. 12. The driving unit is also coupled to a controller configured to control the vibration frequencies and the vibration timing.

The actuator should be fixed so that its mechanical resonance frequency is set to scent dispensing frequency, i.e. ultrasonic. This enables efficient scent dispensing and avoids difficult resonances in the audio frequency range. For ensuring fully separate functionality between scent dispensing and audio sound producing, additional shutter (not shown) between the perfume liquid and the actuator can be used. For example, the shutter is on (closed) when audio is produced, and off (open) when scent is dispensed.

The present invention improves the space utilization in a mobile phone by combining two functions requiring a piezoelectric element. The scent-generating speed or amount can be adjusted by the user by choosing from several predetermined options, such as vibrating frequencies.

The scent dispensing function, according to the present invention, can be implemented by using either active or passive mesh technology.

In an active mesh technology an annular piezoelectric element is used to vibrate a diaphragm in which the middle part is perforated. The tapered holes on the mesh are micron-sized with the larger ends facing towards the liquid perfume chamber, for example. In a passive mesh technology, a piezoelectric element that is used to vibrate a diaphragm or membrane is disposed adjacent to a perforated plate.

In some embodiments of the present invention, a micro-pump or valve is also integrated into the scent dispenser unit so that the same piezoelectric element can be used to pump the liquid perfume into the liquid perfume chamber while vibrating in a low frequency, such as in 1 to 10 Hz range. The vibration of the piezoelectric element in the Hz range causes the diaphragm or membrane to move up and down, thereby producing a pumping action. While the air in the liquid perfume compartment can escape the compartment through the mesh, the liquid accumulated in the compartment is substantially retained as the surface tension and other fluid specific properties prevent it from exiting through the holes on the perforated plate. When the liquid perfume chamber is full, i.e. it has the required perfume dose, the vibration frequency of the piezoelectric element is changed to a higher frequency so that the pumping stops and the atomization starts.

To make the operation of the system orientation independent, the atomizer construction is implemented so that the liquid perfume chamber is so thin that the liquid is in contact with the atomizing surface at all times, regardless of the orientation of the atomizer. Other parts of the orientation dependency and the free positioning of the liquid in the container that it is being stored therein can be solved by integrating a collapsible bag into the fluid container. As the liquid in the collapsible bag is being pulled into the chamber by the pump, the suction force creates a vacuum, thus collapsing the bag and keeping the fluid at the container outlet for providing the liquid perfume to the pump in all orientations.

Due to the fluid specific properties of some liquids, the holes on the mesh plate might have to be very small. These small holes may prevent the air in the liquid perfume compartment from exiting through them. In this case, an overflow pipe controlled by a micro check valve can be used to remove the air. The valve is open during the pumping mode, and closed during scent dispensing.

Normally when a phone rings in response to an incoming call, the caller may not be identified without seeing names on the mobile device display. Scent technologies connected to caller name(s) can be used such that spraying a mist of perfume in the room is carried out when a priorized person/caller is calling. In a loud and heavy traffic environment, a scent in response to a call could be a complementary to a ring-tone or the phone body vibration. Sense of smell can replace some of the impaired senses like hearing or touch.

Adding a scent unit to a mobile device is a way to customize the device. Similar to adding customized display graphics (such as adding a brand name visible to the display, www-pages etc.), memory data information can be integrated to the scent added on package.

The scent dispensing unit, including control electronics, liquid container, dispensing system with micro pump and atomizing unit/spraying head, can be integrated into the sound producing device in a device, such as a mobile phone. Alternatively, the scent dispensing unit can be a separate add-on module to the device to allow the perfume container to be refilled or replaced by a user.

The liquid perfume container can be refillable or interchangeable. The fixation of the interchangeable container to the mobile handset can be done by using quick-release couplings, for example. The container can also be a part of a larger entity, such as an exchangeable unit, which can possibly comprise some other functional packages. In this case the whole module is interchanged. The use of the container is secured by using an RFID (radio frequency identification device) or some other securing method. The liquid in the container is stored in a collapsible bag, to enable the liquid delivery to the container outlet in all orientations.

The scent dispensing functionality can be related to caller identification. Certain callers could have their personalized “smell-tones” to notify when they are calling. If the mobile phone user is not in the same environment with the phone at the time of the call, the phone could use a proximity sensor or something similar to detect when the user enters the environment, and then release the scent again. Using scents as an information delivery channel provides a method for personalized caller identification from a distance, with no physical contact with the device. Adding a movement/touch sensor to the phone to initiate spraying ensures that the information is delivered to the user immediately after entering the surroundings of the phone. Using exchangeable scent unit provides the user with many personalization opportunities limited by the number of existing scent units. Easily exchangeable scent units can be interchanged by the user so as to allow the user to choose a particular scent. As such, the particular scent is dispensed when a special someone has called, or when the phone has received a call from an unknown number.

It is understood that, in many embodiments of the present invention, it is possible that the scent dispensing function is controlled by the user. The user can push one or more keys on the keypad on a mobile handset, for example, to cause the scent dispensing.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method, comprising:
vibrating a vibrateable element in a first frequency range for dispensing at least a part of a scent material stored in a compartment; and
vibrating the vibrateable element in a second frequency range lower than the first frequency range for moving the scent material into the compartment.

2. The method of claim 1, wherein the scent material is stored adjacent to the vibrateable element.

3. The method of claim 1, further comprising:
coupling a second vibrateable element to the vibrateable element, wherein the scent material is stored adjacent to the second vibrateable element, and wherein when the vibrateable element vibrates in the first frequency range, the second vibrateable element vibrates for dispersing the scent material.

4. The method of claim 1, further comprising:
providing a plurality of apertures in the vibrating element so that the scent material is dispersed through at least some of the apertures.

5. The method of claim 3, further comprising:
providing a plurality of apertures in the second vibrating element so that the scent material is dispersed through at least some of the apertures.

6. The method of claim 1, further comprising:
providing a channel between the compartment and a source unit also having the scent material; and
providing a valve at the channel, the valve configured to open in response to vibrations in the second frequency range for moving a part of the scent material in the source unit into the compartment through the channel.

7. The method of claim 1, further comprising:
coupling the vibrateable element to a processor in a mobile handset configured to receive an incoming signal, wherein the vibrateable element is configured to vibrate in the first frequency range in response to the incoming signal.

8. A device, comprising:
a compartment for storing a scent material; and
a vibrateable element configured to vibrate in a first frequency range for dispensing the scent material, and to vibrate in a second lower frequency range for replenishing the scent material in the compartment.

9. The device of claim 8, wherein
the vibrateable element is located in the compartment and the scent material is stored adjacent to the vibrateable element.

10. The device of claim 8, further comprising:
a second vibrateable element coupled to the vibrateable element, the second vibrateable element located in the compartment, wherein the scent material is stored adjacent to the second vibrateable element, and the second vibrateable element is configured to vibrate for dispensing the scent material when the vibrateable element vibrates in the first frequency range.

11. The device of claim 8, wherein the vibrateable element has a plurality of apertures in at least a part of the vibrateable element, wherein the apertures are sized to move at least some of the scent material therethrough when the vibrateable element vibrates in the first frequency range.

12. The device of claim 10, wherein the second vibrateable element has a plurality of apertures in at least a part of the second vibrateable element, wherein the apertures are sized to move at least some of the scent material therethrough when the vibrateable element vibrates in the first frequency range.

13. The device of claim 8, wherein the compartment has a channel configured for linking the compartment to a scent source, said device further comprising:
a valve located at the channel of the compartment, wherein the valve is configured to open in response to vibrations in the second frequency range for moving the scent material from a scent source into the compartment through the channel.

14. The device of claim 13, wherein the compartment has a surface spaced from the vibrateable element by a distance sufficiently small such that a capillary effect is produced for retaining the scent material located between the surface and the vibrateable element.

15. The device of claim 8, wherein the vibrateable element is coupled to a mobile electronic device configured to receive an incoming signal, and wherein the vibrateable element is configured to vibrate in the first frequency range in response to an incoming signal received in mobile electronic device.

16. An apparatus, comprising:
a compartment for storing a scent material;
a vibrateable element located in relationship to the compartment; and
a driving unit coupled to the vibrateable element, wherein the driving unit is configured to vibrate the vibrateable element in a first frequency range for dispensing at least a part of the scent material in the compartment, and to vibrate the vibrateable element in a second lower frequency range for replenishing the scent material in compartment.

17. The apparatus of claim 16, wherein the driving unit is also configured to vibrate the vibrateable element in a third frequency range between the first and second frequency ranges for producing an audio signal.

18. The apparatus of claim 16, further comprising:
a receiver for receiving incoming signals, the receiver is coupled to the driving unit, wherein the driver is configured to vibrate the vibrateable element in the first frequency range in response to the incoming signals.

19. The apparatus of claim 18, wherein the compartment comprises a plurality of sub-compartments, each sub-compartment having a valve, and wherein the scent material comprises a plurality of different scents stored in said different sub-compartments, said apparatus further comprising:
a controller coupled to the receiver, wherein the controller is configured to open the valve of a different one of the sub-compartments in response to a selected one of the incoming signals.

20. The apparatus of claim 16, wherein the compartment has a channel configured for linking to a scent source also having the scent material, and a valve located at the channel, wherein the valve is configured to open in response to vibrations in the second frequency for moving at least part of the scent material in the scent source into the compartment through the channel.

21. The apparatus of claim 16, comprising a mobile electronic device.

22. The apparatus of claim 16, comprising a mobile handset.

23. An apparatus, comprising:
means for storing a scent material;
means for vibrating; and
means, coupled to said vibrating means, for driving said vibrating means to vibrate in the first frequency range for dispensing the scent material, and to vibrate in a second lower frequency for moving the scent material into said storing means.

24. The apparatus of claim 23, further comprising:
means for receiving a signal, coupled to the driving means, wherein the driving means is configured to vibrate the vibrating means in the first frequency range in response to the signal.

25. The apparatus of claim 24, wherein said signal comprises an incoming signal received in a mobile terminal, and wherein said receiving means is coupled to a tranceiver in the mobile terminal to receive the incoming signal.
